(19) United States
(12) Patent Application Publication
(10) Pub. No.: US 2025/0027267 A1
(43) Pub. Date: Jan. 23, 2025

(54) SUBSTRATE COMPRISING GRAPHENE, METHOD OF PREPARATION, AND APPLICATIONS THEREOF

(71) Applicant: RELIANCE INDUSTRIES LIMITED, Mumbai (IN)

(72) Inventors: Joseph Berkmans AMIRTHASAMY, Sivaganga (IN); Vivek Prabhakar RAJE, Thane (IN); Vijay Kumar GARG, Navi Mumbai (IN); Mahendra Kumar SHUKLA, Ahmedabad (IN); Sushant Suresh REKHI, Dombivli (East) (IN)

(21) Appl. No.: 18/549,829

(22) PCT Filed: Mar. 10, 2022
(86) PCT No.: PCT/IB2022/052132

§ 371 Date: Sep. 8, 2023

(30) Foreign Application Priority Data
Mar. 11, 2021 (IN) 202121010336

(51) Int. Cl. D06M 11/74; C01B 32/194; C09D 11/037; C09D 11/102; C09D 11/107; C09D 11/52; C09K 5/14; D06M 16/00; D06P 1/52; D06P 1/673; D06P 5/15

(52) U.S. Cl. CPC D06M 11/74; C01B 32/194; C09D 11/037; C09D 11/102; C09D 11/107; C09D 11/52; C09K 5/14; D06M 16/00; D06P 1/525; D06P 1/5285; D06P 1/673; D06P 5/151; C01B 2204/32; C01P 2006/12; D06M 2200/25

(57) ABSTRACT

A substrate including graphene and/or its derivative(s), wherein the substrate including graphene and/or its derivative(s) is characterized by features selected from the group consisting of anti-microbial, antistatic, wicking, thermal cooling, anti-odour, ultraviolet protection, or combinations thereof. The substrate including graphene and/or its derivative(s) shows several further beneficial properties including but not limited to good/excellent washing fastness, rubbing fastness, perspiration fastness, sublimation fastness, and light fastness.

### TECHNICAL FIELD

The present disclosure relates to substrate possessing feature selected from a group comprising anti-microbial, antistatic, wicking, thermal cooling, anti-odour, ultraviolet protection and combinations thereof. More particularly, the present disclosure provides substrate comprising graphene and/or its derivative(s), wherein said graphene comprising substrate are characterized by feature selected from a group comprising anti-microbial, antistatic, wicking, thermal cooling, anti-odour, ultraviolet protection and combinations thereof. Said graphene comprising substrate of the present disclosure show several further beneficial properties including but not limited to good/excellent washing fastness, rubbing fastness, perspiration fastness, sublimation fastness and light fastness.

### BACKGROUND OF THE DISCLOSURE

Fabrics (synthetic, natural and their blends) such as polyester are widely used as garment materials, sports wears, apparels in hospitals, medical devices, air purifiers and auto motive textile applications due to its high tenacity and durability and any polymer, metal and ceramic substrates for applications for smart wears, AI enabled technologies advanced telecommunications, devices and sensors. However, virgin fabrics have tendency to absorb moisture and grow microorganisms such as bacteria and fungi on their surface and don't have any inherent ability to hamper the growth of microorganisms. Such microorganisms cause adverse effects to the textiles and the consumers. Many anti-microbial agents and their use in preparing anti-microbial textiles are known. For instance, silver nanoparticles are known to be effective and is a widely studied anti-microbial agent for textile applications. However, cost and the release of the metallic nanoparticles to the environment remain to be challenges.

Synthetic Fabrics (such as polyester) and their blends are widely used as garment materials and auto motive textile applications due to its high tenacity and durability. Unprocessed grey polyester fabrics accumulate static charges on their surface naturally which affects the comfort of the fabric in many applications such as apparels. Anti-static agents generally employed in the art typically increase the electrical conductivity of the fabric by forming hygroscopic intermediate layers on the fabric surface that absorb moisture and enhance conductivity. However, said absorption of moisture for achieving anti-static effect interferes with properties such as wicking and thermal cooling. Said properties of wicking and thermal cooling are extremely important for the comfort of the wearer especially in the case of garments such as sportswear wherein anti-microbial effect of the fabric is also important for purposes of hygiene.

Taken together, there is a requirement for substrates such as polymers, plastics, material other than polymers-conductors, metals, semiconductors, insulators possessing a combination of multiple beneficial characteristics as a whole, wherein all characteristics exist simultaneously without interfering with each other. The present disclosure tries to address said need.

### SUMMARY OF THE DISCLOSURE

Addressing the aforesaid need in the art, the present disclosure provides a substrate comprising graphene at an amount ranging from about 0.0001% (w/w) to 10% (w/w), said substrate characterized by feature selected from a group comprising antimicrobial, antistatic, anti-odour, wicking, thermal cooling, ultraviolet protection and combinations thereof, wherein the substrate is selected from a group comprising fabrics, polymers, plastics, material other than polymers such as conductors, metals, semiconductors and insulators.

In some embodiments, the fabric is selected from the group comprising natural fabric, synthetic fabric, a blend of natural fabric and synthetic fabric, and combinations thereof; and the graphene is a graphene, a graphene derivative or a combination thereof.

In some embodiments, the substrate comprising graphene is characterized by feature selected from a group comprising bactericidal, antibacterial effect, bacteriostatic effect, antiviral effect, antifungal effect and combinations thereof; wherein the substrate comprising graphene is characterized by a bactericidal effect ranging from about 90% to 99.999% against Staphylococcus aureus, Klebsiella pneumonia, and Escherichia coli; wherein the substrate comprising graphene is characterized by a bacteriostatic effect ranging from about 90% to 99.999% against Staphylococcus aureus, Klebsiella pneumonia, and Escherichia coli; wherein the substrate comprising graphene is characterized by an antiviral effect ranging from about 90% to 99.999% against MS2 bacteriophage; or wherein the substrate comprising graphene is characterized by an antifungal effect ranging from about 90% to 99.999% against Aspergillus Niger and Candida Albicans.

In some embodiments, the substrate comprising graphene is characterized by half decay time for discharge of charge applied on the substrate surface which ranges from about 0.01 seconds to 3 seconds, anti-odour effect measured by AATCC 100 standard which ranges from about 90% to 99.999%, wicking effect measured by AATCC 197:2013 standard which ranges from about 2 inches/3 minutes to about 5 inches/30 minutes, thermal cooling measured by Q-Max which ranges from about 0.1 watts per square centimeter (W/cm²) to 0.7 W/cm², electrical resistivity ranging from about 50 Ohm/sq to 1600 k Ohm/sq, and ultraviolet protection measured by ultraviolet protection factor (UPF) which ranges from about 30 to 130.

The said substrate comprising graphene, in some embodiments, has a washing fastness, perspiration fastness, sublimation fastness and light fastness of about 4 to 5; and water absorbency of 0.1 Sec to 5 Sec.

In some embodiments, the antimicrobial, antistatic, anti-odour, wicking, thermal cooling and ultraviolet protection features of the substrate comprising graphene of the present disclosure are maintained after 50 washes or more.

The present disclosure further provides a method of preparing a substrate comprising graphene, said substrate characterized by feature selected from a group comprising antimicrobial, antistatic, anti-odour, wicking, thermal cooling, ultraviolet protection and combinations thereof, the method comprising printing graphene slurry on a substrate.

In some embodiments, printing the graphene comprises:
a) preparing a graphene slurry; and
b) printing a substrate with the graphene slurry to prepare the substrate comprising graphene.

In some embodiments, the graphene slurry is prepared by dispersing graphene in a solvent, followed by high shear mixing to obtain a homogenous and concentrated graphene slurry. The slurry is mixed with the binder such as acrylate, poly urethane and combinations thereof before printing on the substrate. The ratio of binder to slurry is ranging from about 10:1 to 1:10.

The present disclosure further provides use of graphene slurry comprising graphene at an amount ranging from about 0.0001 to 20% (w/w) for preparing a substrate characterized by feature selected from a group comprising antimicrobial, antistatic, anti-odour, wicking, thermal cooling, ultraviolet protection and combinations thereof.

### DETAILED DESCRIPTION OF THE DISCLOSURE

In view of the limitations discussed above, and to remedy the need in the art for substrate products characterized by feature selected from a group comprising anti-microbial, anti-static, anti-odour, wicking, thermal cooling, ultraviolet protection, and combinations thereof, the present disclosure aims to provide a substrate comprising graphene at a controlled concentration. In particular, the present disclosure relates to a substrate comprising graphene and/or its derivatives incorporated into it. The disclosure also provides a corresponding process for preparing such graphene containing substrate and corresponding beneficial properties obtained thereof.

However, before describing the invention in greater detail, it is important to take note of the common terms and phrases that are employed throughout the present disclosure for better understanding of the technology provided herein.

Throughout the present disclosure, the term ‘graphene’ is intended to convey the ordinary conventional meaning of the term known to a person skilled in the art and intends to cover ‘graphene’ as an allotrope of carbon consisting of a single or multiple layers of carbon atoms. Thus, the graphene employed in the present disclosure may be a single layered or multi layered graphene. The graphene employed herein is preferably of high surface area, typically ranging between 100 m²/g to 2000 m²/g, more typically between 300 m²/g to 800 m²/g. In non-limiting embodiments, the surface area of graphene incorporated into the substrate of the present disclosure is about 100 m²/g, about 200 m²/g, 300 m²/g, 400 m²/g, 500 m²/g, 600 m²/g, 700 m²/g, 800 m²/g, 900 m²/g, 1000 m²/g, 1100 m²/g, 1200 m²/g, 1300 m²/g, 1400 m²/g, 1500 m²/g, 1600 m²/g, 1700 m²/g, 1800 m²/g, 1900 m²/g or 2000 m²/g.

Throughout the present disclosure, the term ‘graphene derivatives’, ‘derivatives of graphene’ or the likes is intended to convey the ordinary conventional meaning of the term known to a person skilled in the art and intends to cover structural analogs of graphene, or compounds derived from graphene and having similar characteristics of graphene. In some embodiments of the disclosure, graphene derivatives encompass monolayer graphene, bilayer graphene, trilayer graphene, few layers graphene, multi-layer graphene, graphene nanoplatelets, graphene oxides, reduced graphene oxides, functionalized graphene, graphene decorated with metal particles, nanosized graphene, graphene quantum dots or any graphene containing material.

In some embodiments of the disclosure, graphene derivatives encompass functionalized graphene. Further, said term ‘functionalized’ or ‘functionalization’ is used interchangeably and is intended to convey the ordinary conventional meaning of the term known to a person skilled in the art in the field of polymer or material science, and intends to cover a process of adding new functions, features, capabilities, or properties to a material by changing the surface chemistry of the material. In the context of graphene employed in the present disclosure, the term is used to cover functionalization of graphene including reactions of graphene (and its derivatives) with organic and/or inorganic molecules, chemical modification of the graphene surface, and the interaction of various covalent and noncovalent components with graphene.

The functionalization of graphene is surface modification used to reduce the cohesive force between the graphene sheets and to manipulate the physical and chemical properties of graphene.

Throughout the present disclosure, the terms ‘fabric’, ‘fibre’, ‘yarn’, ‘textile’, ‘cloth’ or the likes are intended to convey the ordinary conventional meaning of the terms known to a person skilled in the art and intends to cover natural fabric, synthetic fabric and blends of natural and/or synthetic fabric. In some embodiments of the disclosure, the term ‘fabric’ also encompasses ‘fibres’ or ‘yarn’ forming said fabric. Accordingly, in the context of the present disclosure, reference to ‘graphene-containing fabric’ envisages in ‘graphene-containing fibre’ and ‘graphene-containing yarn’. Further, ‘fabric’ encompasses unprocessed/virgin fabric and/or processed/partially processed fabric.

Throughout the present disclosure, the terms/phrases ‘graphene infused substrate or ‘graphene incorporated substrate’ or ‘graphene printed substrate’ or ‘substrate comprising graphene’ or ‘graphene-containing substrate’ are used interchangeably and refer to the feature of substrate comprising graphene printed onto it, wherein the substrate includes but not limited to fabrics, polymers, plastics, material other than polymers such as conductors, metals, semiconductors and insulators.

Throughout the present disclosure, the terms/phrases ‘graphene infused fabric’ or ‘graphene incorporated fabric’ or ‘graphene printed fabric’ or ‘fabric comprising graphene’ or ‘graphene-containing fabric’ are used interchangeably and refer to the feature of fabric comprising graphene printed onto it.

As used herein, the term ‘fabric coating agent’ refers to agents routinely used to coat fabric to yield longer lasting, stronger, and more weather resistant fabric. In the context of the present disclosure, it refers to standard/conventional coating agents optionally added to the coating solution, apart from those explicitly mentioned herein.

The term ‘anti-microbial’ and obvious variants thereof as used in the present disclosure, refers to the characteristic of the fabric comprising graphene of the present disclosure that exerts destructive or inhibitory effect on the growth of microorganisms, including bacteria, viruses, and fungi.

As used herein, the term ‘anti-bacterial’ refers to bacteriostatic or bactericidal activity of the fabric comprising graphene, wherein ‘bacteriostatic’ typically means that the agent prevents the growth of bacteria (i.e., it keeps them in the stationary phase of growth), and ‘bactericidal’ means that it kills bacteria. In reality, there are not 2 pure categories of antimicrobial agents (one that exclusively kills bacteria and another that only inhibits growth). Most anti-bacterials are better described as potentially being both bactericidal and bacteriostatic.

As used herein, the term ‘anti-viral’ refers to the ability of the fabric comprising graphene to kill a virus or suppress its ability to replicate and, hence, inhibits its capability to multiply and reproduce.

As used herein, the term ‘anti-fungal’ refers to the ability of the fabric comprising graphene to limit or prevent the growth of yeasts and other fungal organisms.

The term ‘anti-static’ and obvious variants thereof refer to the characteristic of the fabric comprising graphene of the present disclosure typically relating to reduction or elimination of build-up of static electricity.

The term ‘wicking’ and obvious variants thereof refer to a technical feature of the fabric comprising graphene of the present disclosure which draws moisture away from the body.

The term ‘thermal cooling’ and obvious variants thereof refer to the characteristic of the fabric comprising graphene that allows thermal regulation due to the thermal conductivity of the fabric. Said feature allows body heat to pass through the fabric by conduction/convection to the ambient environment.

The term ‘UV protection’ and obvious variants thereof refer to the protective effect exerted by the fabric comprising graphene against sun's ultraviolet (UV) radiation. Unless otherwise mentioned, Ultraviolet Protection Factor (UPF) is used as a measuring parameter of the ‘UV protection’ characteristic of the fabric.

‘Washing fastness’ refers to the ability of the graphene to maintain improved adhesion on the fabric under the washing and rubbing condition.

‘Blend’ it the context of the present disclosure refers to ‘blended fabric’ or a ‘fabric blend’, wherein said blended fabric is formed from fibres or yarn formed by combining fibres of different origins, length, thickness, or colour.

The terms ‘graphene slurry’ as referred to herein refer to the graphene containing solution applied to the fabric of the present disclosure that comprises graphene and/or its derivatives optionally along with two or more coating or dyeing agents/components.

Accordingly, to reiterate, the present disclosure relates to a substrate comprising graphene and/or its derivatives, wherein said substrate is specifically characterized feature selected from a group comprising anti-microbial, antistatic, anti-odour, wicking, thermal cooling, ultraviolet protection and combinations thereof, wherein the substrate includes but not limited to fabrics, polymers, plastics, material other than polymers such as conductors, metals, semiconductors and insulators.

In some embodiments, the present disclosure relates to a fabric comprising graphene and/or its derivatives, wherein said fabric is specifically characterized feature selected from a group comprising anti-microbial, antistatic, anti-odour, wicking, thermal cooling, ultraviolet protection and combinations thereof.

Particularly provided by the present disclosure is a substrate comprising graphene at an amount ranging from about 0.0001% (w/w) to 10% (w/w), said substrate characterized by feature selected from a group comprising anti-microbial, antistatic, anti-odour, wicking, thermal cooling, ultraviolet protection and combination thereof, wherein the substrate includes but not limited to fabrics, polymers, plastics, material other than polymers such as conductors, metals, semiconductors and insulators.

In some embodiments, the present disclosure relates to fabric comprising graphene at an amount ranging from about 0.0001% (w/w) to 10% (w/w), said fabric characterized by feature selected from a group comprising anti-microbial, antistatic, anti-odour, wicking, thermal cooling, ultraviolet protection and combination thereof.

In some embodiments, the present disclosure relates to fibre(s) comprising graphene at an amount ranging from about 0.0001% (w/w) to 10% (w/w), said fibre(s) characterized by feature selected from a group comprising anti-microbial, antistatic, anti-odour, wicking, thermal cooling, ultraviolet protection, and combinations thereof.

In some embodiments, the present disclosure relates to yarn(s) comprising graphene at an amount ranging from about 0.0001% (w/w) to 10% (w/w), said yarn(s) is characterized by feature selected from a group comprising anti-microbial, antistatic, anti-odour, wicking, thermal cooling, ultraviolet protection combinations thereof.

As defined above, the graphene incorporated fabric comprises graphene and/or its derivatives at a concentration ranging from about 0.0001% (w/w) to 10% (w/w) with respect to the weight of the fabric, including all values or ranges derivable therefrom. Said graphene-containing fabric of the present disclosure is by the mandatory presence of feature selected from a group comprising anti-microbial, antistatic, anti-odour, wicking, thermal cooling, ultraviolet protection and combinations thereof.

In some embodiments, the graphene incorporated fabric of the present disclosure comprises graphene and/or its derivatives at a concentration ranging from about 0.0001% (w/w) to 10% (w/w) with respect to the weight of the fabric, including all values or ranges derivable therefrom and the graphene incorporated fabric has anti-microbial, antistatic, anti-odour, wicking, thermal cooling and ultraviolet protection features.

In some embodiments, the present disclosure provides a Fabric having any combination of features selected from the combinations indicated in Table 1. In Table 1, X represents presence of the feature as part of the combination encompassed in each row. Accordingly, every single combination provided in Table 1 represents a separate embodiment of the present disclosure. However, the present disclosure also envisages a merger or mixture of these embodiments to provide for further possible combinations. Thus, for the purposes of the present disclosure, each of the combinations that are derivable from Table 1 below are envisaged to exist individually, all together or in different combinations within the ambit of the present disclosure.

TABLE 1

| | Graphene at | | | | | | |
|---|---|---|---|---|---|---|---|
| | an amount | | | | | | |
| | ranging from | | | | | | |
| | about 0.0001% | | | | | | |
| | (w/w) to 1% | | | | | Thermal | Ultraviolet |
| Polymer fabric | (w/w) | Anti-microbial | Antistatic | Anti-odour | Wicking | cooling | protection |
| Polymer fabric A | X | X | X | X | | | |
| Polymer fabric B | X | X | X | | X | | |
| Polymer fabric C | X | X | X | | | X | |
| Polymer fabric D | X | X | X | | | | X |
| Polymer fabric E | X | X | | X | X | | |
| Polymer fabric F | X | X | | X | | X | |
| Polymer fabric G | X | X | | X | | | X |
| Polymer fabric H | X | X | | | X | X | |
| Polymer fabric I | X | X | | | X | | X |
| Polymer fabric J | X | X | | | | X | X |
| Polymer fabric K | X | X | X | X | X | | |
| Polymer fabric L | X | X | X | X | | X | |
| Polymer fabric M | X | X | X | X | | | X |
| Polymer fabric N | X | X | X | | X | X | |
| Polymer fabric O | X | X | X | | X | | X |
| Polymer fabric P | X | X | | X | X | X | |
| Polymer fabric Q | X | X | | X | X | | X |
| Polymer fabric R | X | X | | X | | X | X |
| Polymer fabric S | X | X | X | | | X | X |
| Polymer fabric T | X | X | | | X | X | X |
| Polymer fabric U | X | | X | X | X | X | |
| Polymer fabric V | X | | X | X | X | | X |
| Polymer fabric W | X | | X | X | | X | X |
| Polymer fabric X | X | | | X | X | X | X |
| Polymer fabric Y | X | X | X | X | X | X | |
| Polymer fabric Z | X | | X | X | X | X | X |
| Polymer fabric A′ | X | X | | X | X | X | X |
| Polymer fabric B′ | X | X | X | | X | X | X |
| Polymer fabric C′ | X | X | X | X | | X | X |
| Polymer fabric D′ | X | X | X | X | X | | X |
| Polymer fabric E′ | X | X | X | X | X | X | X |
| Polymer fabric F′ | X | X | | | | | |
| Polymer fabric G′ | X | | X | | | | |
| Polymer fabric H′ | X | | | X | | | |
| Polymer fabric I′ | X | | | | X | | |
| Polymer fabric J′ | X | | | | | X | |
| Polymer fabric K′ | X | | | | | | X |
| Polymer fabric L′ | X | X | X | | | | |
| Polymer fabric M′ | X | X | | X | | | |
| Polymer fabric N′ | X | X | | | X | | |
| Polymer fabric O′ | X | X | | | | X | |
| Polymer fabric P′ | X | X | | | | | X |
| Polymer fabric R′ | X | | X | X | | | |
| Polymer fabric S′ | X | | X | | X | | |
| Polymer fabric T′ | X | | X | | | X | |
| Polymer fabric U′ | X | | X | | | | X |
| Polymer fabric W′ | X | | | X | X | | |
| Polymer fabric X′ | X | | | X | | X | |
| Polymer fabric Y′ | X | | | X | | | X |
| Polymer fabric Z′ | X | | | | X | X | |
| Polymer fabric A″ | X | | | | X | | X |

As can be observed from the above, the concentration of graphene contained in the fabric remaining between 0.0001% (w/w) to 10% (w/w) plays an important role in mediating the mentioned features selected from a group comprising anti-microbial, antistatic, anti-odour, wicking, thermal cooling, ultraviolet protection and combinations thereof. Each of the above combination of features is further characterized by features such as but not limited to good/excellent washing fastness, rubbing fastness, perspiration fastness, sublimation fastness and light fastness.

In some embodiments, the substrate comprising graphene of the present disclosure is characterized by an increase of about 1 fold to about 10 fold of anti-microbial, antistatic, anti-odour, wicking, thermal cooling and ultraviolet protection when compared to a fabric lacking graphene.

Accordingly, the substrate comprising graphene of the present disclosure is characterized by the following features—
about 1 fold to about 10 fold increase in anti-microbial activity;
about 1 fold to about 10 increase in antistatic activity;
about 1 fold to about 10 increase in anti-odour activity;
about 1 fold to about 10 increase in wicking efficiency;
about 1 fold to about 10 increase in thermal cooling; and
about 1 fold to about 10 increase in ultraviolet protection
when compared to a substrate lacking graphene.

In some embodiments, the substrate comprising graphene of the present disclosure is characterized by an increase of about 1 fold, about 2 fold, about 3 fold, about 4 fold, about 5 fold, about 6 fold, about 7 fold, about 8 fold, about 9 fold or about 10 fold in the feature selected from a group comprising anti-microbial, antistatic, anti-odour, wicking, thermal cooling, ultraviolet protection and combination thereof when compared to a substrate lacking graphene.

In some embodiments, the anti-microbial activity comprises bactericidal or antibacterial effect, bacteriostatic effect, antiviral effect, antifungal effect and combinations thereof. In some embodiments, the substrate comprising graphene is characterized by a bactericidal effect ranging from about 90% to 99.999%, including all values or ranges derivable therefrom, against Staphylococcus aureus, Klebsiella pneumonia, and Escherichia coli.

In exemplary embodiments, the substrate comprising graphene is characterized by a bactericidal effect ranging from about 99.94% to 99.95%, including all values or ranges derivable therefrom, against Staphylococcus aureus, Klebsiella pneumonia, and Escherichia coli.

In some embodiments, the substrate comprising graphene is characterized by a bacteriostatic effect ranging from about 90% to 99.999%, including all values or ranges derivable therefrom, against Staphylococcus aureus, Klebsiella pneumonia, and Escherichia coli.

In some embodiments, the substrate comprising graphene is characterized by a bacteriostatic effect comprising log reduction of bacterial value ranging from about 2 to 5, including all values or ranges derivable therefrom, against Staphylococcus aureus, Klebsiella pneumonia, and Escherichia coli.

In some embodiments, the substrate comprising graphene is characterized by an antiviral effect ranging from about 90% to 99.999%, including all values or ranges derivable therefrom, against M2 bacteriophage.

In some embodiments, the substrate comprising graphene is characterized by an antiviral effect ranging from about 99.9% to 99.999%, including all values or ranges derivable therefrom, against M2 bacteriophage.

In some embodiments, the substrate comprising graphene is characterized by an antiviral effect comprising a log reduction of virus value ranging from about 2 to 5 against M2 bacteriophage.

In some embodiments, the substrate comprising graphene is characterized by an antifungal effect ranging from about 90% to 99.999%, including all values or ranges derivable therefrom, against Aspergillus niger and Candida albicans.

In some embodiments, the substrate comprising graphene is characterized by antistatic effect measured by half decay time for discharge of charge applied on the substrate surface which ranges from about 0.01 seconds to 3 seconds, including all values or ranges derivable therefrom. In some embodiments, the static discharge half decay time of the graphene incorporated substrate at a temperature of about 25° C. and at about 45% relative humidity ranges from about 0.01 seconds to 3 seconds.

In some embodiments, the substrate comprising graphene is characterized by anti-odour effect measured by AATCC 100 standard which ranges from about 90% to 99.999%, including all values or ranges derivable therefrom.

In some embodiments, the substrate comprising graphene is characterized by thermal cooling measured by Q-Max which ranges from about 0.1 watts per square centimetre (W/cm²) to 0.7 W/cm², including all values or ranges derivable therefrom.

In some embodiments, the substrate comprising graphene is characterized by ultraviolet protection measured by ultraviolet protection factor (UPF) which ranges from about 30 to 130, including all values or ranges derivable therefrom.

In some embodiments, the substrate comprising graphene of the present disclosure has very good to excellent washing fastness, perspiration fastness, sublimation fastness and light fastness.

In some embodiments, the substrate comprising graphene of the present disclosure has washing fastness, perspiration fastness, sublimation fastness and light fastness of about 4 to 5 as measured on a standard rating scale wherein 1—is very poor, 2-3 is good, 3-4 is very good and 4-5 is excellent.

In some embodiments, the substrate comprising graphene of the present disclosure has water absorbency of about 0.1 seconds to about 5 seconds, including all values or ranges derivable therefrom.

In some embodiments, the substrate comprising graphene of the present disclosure has electrical resistivity ranging from about 50 Ohm/sq to 1600 k Ohm/sq, including all values or ranges derivable therefrom.

In some embodiments, the substrate comprising graphene of the present disclosure has electrical resistance ranging from about 50 Ohm to 1000 k Ohm, including all the values or ranges derivable therefrom

The inventors have particularly identified that the substrate comprising graphene and/or its derivative having concentration ranging from about 0.0001% (w/w) to 10% (w/w), including all the values in the range, for instance, 0.0002% (w/w), 0.0003% (w/w), 0.0004% (w/w), 0.0005% (w/w), 0.0006% (w/w) and so on and so forth, provides for improved electrical resistivity ranging from about 50 Ohm/sq to 1600 k Ohm/sq, including all the values in the range, for instance, 51 Ohm/sq, 52 Ohm/sq, 53 Ohm/sq, 54 Ohm/sq and so on and so forth and improved electrical resistance ranging from about 50 Ohm to 1000 k Ohm, including all the values in the range, for instance, 51 Ohm, 52 Ohm, 53 Ohm, 54 Ohm and so on and so forth. In an embodiment, the substrate comprising the graphene and/or derivative at a concentration ranging from about 0.0001% (w/w) to 10% (w/w), including all the values in the range, for instance, 0.0002% (w/w), 0.0003% (w/w), 0.0004% (w/w), 0.0005% (w/w), 0.0006% (w/w) and so on and so forth, provides for low conductivity or negligible conductivity.

In some embodiments, the anti-microbial, antistatic, anti-odour, wicking, thermal cooling and ultraviolet protection features of the fabric comprising graphene of the present disclosure are maintained even after at least 50 washes of the substrate.

In some embodiments, the graphene incorporated substrate comprises graphene and/or its derivatives at a concentration of about 0.0001% (w/w), about 0.00015% (w/w), about 0.0002% (w/w), about 0.00025% (w/w), about 0.0003% (w/w), about 0.00035% (w/w), about 0.0004% (w/w), about 0.00045%, about 0.0005% (w/w), about 0.00055% (w/w), about 0.0006% (w/w), about 0.00065% (w/w), about 0.0007% (w/w), about 0.00075% (w/w), about 0.0008% (w/w), about 0.00085% (w/w), about 0.0009% (w/w), about 0.00095% (w/w), about 0.001% (w/w), about 0.0015% (w/w), about 0.002% (w/w), about 0.0025% (w/w), about 0.003% (w/w), about 0.0035% (w/w), about 0.004% (w/w), about 0.0045% (w/w), about 0.005% (w/w), about 0.0055% (w/w), about 0.006% (w/w), about 0.0065% (w/w), about 0.007% (w/w), about 0.0075% (w/w), about 0.008% (w/w), about 0.0085% (w/w), about 0.009% (w/w), about 0.0095% (w/w), about 0.01% (w/w) about 0.015% (w/w), about 0.02% (w/w), about 0.025% (w/w), about 0.03% (w/w), about 0.035% (w/w), about 0.04% (w/w), about 0.045% (w/w), about 0.05% (w/w), about 0.055% (w/w), about 0.06% (w/w), about 0.065% (w/w), about 0.07% (w/w), about 0.075% (w/w), about 0.08% (w/w), about 0.085% (w/w), about 0.09% (w/w), about 0.095% (w/w), about 0.1% (w/w), about 0.15% (w/w), about 0.2% (w/w), about 0.25% (w/w), about 0.3% (w/w), about 0.35% (w/w), about 0.40% (w/w), about 0.45% (w/w), about 0.5% (w/w), about 0.55% (w/w), about 0.6% (w/w), about 0.65% (w/w), about 0.7% (w/w), about 0.75% (w/w), about 0.8% (w/w), about 0.85%, about 0.9% (w/w), about 0.95% (w/w), about 1% (w/w), about 2% (w/w), about 3% (w/w), about 4% (w/w), about 5% (w/w), about 6% (w/w), about 7% (w/w), about 9% (w/w) or about 10% (w/w).

In some embodiments of the present disclosure, the substrate comprising graphene, comprises graphene and/or its derivatives at an amount ranging from about 0.0001% (w/w) to 0.0049% (w/w).

In some embodiments of the present disclosure, the least thickness of graphene on the substrate is one carbon atom thickness.

In some embodiments of the present disclosure, the graphene derivatives are selected from a group comprising monolayer graphene, bilayer graphene, trilayer graphene, few layer graphene, multi-layer graphene, graphene nanoplatelets, graphene oxides, reduced graphene oxides, functionalized graphene, graphene decorated with metal particles, nanosized graphene, graphene quantum dots, any graphene containing material, and combinations thereof.

In some embodiments of the present disclosure, the graphene and/or its derivative is a combination of single layer and multilayer graphene. In an embodiment, about 75% to 85% of the graphene and/or its derivative is single layer and about 15% to 25% of graphene comprises about 2 to 5 layers graphene. In an embodiment, about 15% to 25% of graphene comprises about 2 layers, about 3 layers, about 4 layers or about 5 layers of graphene.

In an alternate embodiment, about 80% of the graphene and/or its derivative is single layer and about 20% of the graphene comprises about 2 to 5 layers graphene. In an embodiment, about 20% of the graphene comprises about 2 layers, about 3 layers, about 4 layers or about 5 layers of graphene.

It is important to note that while single layer graphene has all the desired attributes in its highest form, obtaining a 100% single layer graphene requires labour intensive processes and thus increases the cost. Moreover, 100% single layer graphene has extremely high surface area which makes it difficult to process. These drawbacks are overcome by use of a graphene composition which is a combination of single and multi-layered graphene, and comprises about 80% to about 85% of single layered graphene, and about 15% to about 20% multi-layered graphene, wherein the multi-layered graphene is made up of about 2 to about 5 layers of graphene. Such a combination of graphene possesses all the required attributes for preparing the product (polymer fibre or fabric) of the present disclosure with surface areas that are optimum for processing. However, it is crucial to note that arriving at such a graphene combination that comprises both single and multi-layered graphene is not direct and straightforward. This is because the surface area of a graphene is inversely proportional to the number of layers present in the said graphene. When the number of layers increases, the available surface area decreases and vice versa. While a very low surface area (with high number of layers) is detrimental as it adversely impacts the resulting properties and outcome, a very high surface area also makes processing of the graphene so much more challenging and process intensive. Thus, a critical balance between the number of layers and the surface area of the selected graphene is required to achieve the desired results in the present disclosure.

In some embodiments of the present disclosure, the graphene and or its derivative has surface area ranging from about 300 m²/g to 800 m²/g, including all the values in the range, for instance, 301 m²/g, 302 m²/g, 303 m²/g, 304 m²/g and so on and so forth.

In some embodiments of the present disclosure, the graphene and or its derivative has surface area ranging from about 400 m²/g to 500 m²/g, including all the values in the range, for instance, 401 m²/g, 402 m²/g, 403 m²/g, 404 m²/g and so on and so forth.

In some embodiments of the present disclosure, the fabric is selected from a group comprising natural fabric, synthetic fabric, blend of natural fabric and synthetic fabric, and combinations thereof.

In some embodiments of the present disclosure, the natural fabric is selected from a group comprising fabric derived from Alpaca, Angora wool, Azlon, Byssus, Camel hair, Cashmere wool, Chiengora, Lambswool, Llama, Mohair wool, Qiviut, Rabbit, Silk, Vicuña, Wool, Yak, Abacá, Acetate, Bamboo, Banana, Kapok, Coir, Cotton, Flax, Hemp, Jute, Kenaf, Lyocell, Modal, Piña, Raffia, Ramie, Rayon, Sisal, Soy protein and combinations thereof.

In some embodiments of the present disclosure, the synthetic fabric is selected from a group comprising Acetate, Acrylic, Lyocell, Modacrylic, Microfibre, Nomex, Nylon, Polyester, Polypropylene, Polyvinyl chloride, Rayon/Viscose, Spandex, Kevlar and combinations thereof.

In some embodiments of the present disclosure, the blended fabric is a fabric derived from any combination of materials selected from a group comprising Alpaca, Angora wool, Azlon, Byssus, Camel hair, Cashmere wool, Chiengora, Lambswool, Llama, Mohair wool, Qiviut, Rabbit, Silk, Vicuña, Wool, Yak, Abacá, Acetate, Bamboo, Banana, Kapok, Coir, Cotton, Flax, Hemp, Jute, Kenaf, Lyocell, Modal, Piña, Raffia, Ramie, Rayon, Sisal, Soy protein, Acetate, Acrylic, Lyocell, Modacrylic, Microfibre, Nomex, Nylon, Polyester, Polypropylene, Polyvinyl chloride, Rayon/Viscose, Spandex and Kevlar.

In an embodiment of the present disclosure, the graphene or its derivatives is printed on the fabric.

In some embodiments of the present disclosure, the graphene in an amount ranging from about 0.0001% (w/w) to 10% (w/w) in the substrate possess extraordinary anti-microbial properties along with mechanical, thermal, electrical properties. In the said graphene at the mentioned amount, the physical structure and chemically functionalized groups of the graphene has the ability to kill and control the growth of microorganisms and therefore provides anti-bacterial activity to graphene. Further, the graphene in the said amount have carbon in the form of sharp edges and spikes that act as a sharp knife which cause irreversible damages to the cell membranes of the bacteria and kills them. The functionalized groups of graphene in the said amount ranging from about 0.0001% (w/w) to 10% (w/w) react chemically with the anti-oxidant groups of the bacteria (GSH-glutathione) in the cell membrane that oxidises said anti-oxidant groups of bacteria and induces oxidative stress which kill the bacteria. Accordingly, due to the above mechanisms and the synergetic effect of physical and chemical destructions to the cell membranes of bacteria, graphene in the said amount is considered as a strong antibacterial/anti-microbial agent and provide better/improved antibacterial/anti-microbial activity compared to the currently available anti-microbial agents.

In some embodiments of the present disclosure, the graphene in an amount ranging from about 0.0001% (w/w) to 10% (w/w) in the substrate possesses extraordinary electrical properties due to overlapping of π-orbitals. The in-plane electrical conductivity of monolayer graphene is about 1×10⁻⁶ ohm·cm with an electron mobility of about 200000 cm²/Vs. Thus, printing the graphene in an amount ranging from about 0.0001% (w/w) to 10% (w/w) on substrate greatly enhances the electrical conductivity and thus improves the anti-static property of the substrate. Accordingly, the graphene in an amount ranging from about 0.0001% (w/w) to 10% (w/w) is considered to confer to substrate more efficient and durable anti-static properties as compared to the currently available anti-static agents. Anti-static agents typically employed in the art increase the electrical conductivity of the fabric by forming hygroscopic intermediate layers on the fabric surface that absorb moisture and enhance conductivity. However, said absorption of moisture for achieving anti-static effect interferes with properties of the fabric such as wicking and thermal cooling, which are important for breathability of the fabric. Said properties of wicking and thermal cooling are extremely important for the comfort of the wearer especially in the case of fabric for garments such as sportswear or uniforms wherein in addition to features such as anti-static and anti-microbial, features such as wicking and thermal cooling of the fabric are also important for purposes of hygiene and comfort. Accordingly, the present invention provides a simple yet effective solution to said problem by providing a substrate including but not limited to fabrics, polymers, plastics, material other than polymers such as conductors, metals, semiconductors and insulators comprising graphene in an amount ranging from about 0.0001% (w/w) to 10% (w/w) that has all of the aforesaid properties additionally along with UV protection.

The present disclosure further relates to the preparation/production of graphene incorporated substrate including but not limited to fabrics, polymers, plastics, material other than polymers such as conductors, metals, semiconductors and insulators. In some embodiments of the present disclosure, the production of graphene incorporated substrate comprises incorporating graphene and/or its derivatives in the substrate by printing techniques.

Accordingly, the present disclosure further provides a method of preparing a substrate comprising about 0.0001% (w/w) to 10% (w/w) graphene, said substrate characterized by features selected from a group comprising anti-microbial, antistatic, anti-odour, wicking, thermal cooling, ultraviolet protection, and combinations thereof, the method comprising printing graphene on a substrate including but not limited to fabrics, polymers, plastics, material other than polymers such as conductors, metals, semiconductors and insulators.

In some embodiments, in the method of preparing the graphene incorporated substrate of the present disclosure, the step of printing the graphene comprises:
a) preparing a graphene slurry; and
b) printing a substrate with the graphene slurry, to prepare the graphene incorporated fabric.

In some embodiments, the graphene slurry is prepared by dispersing graphene in a solvent, followed by mixing to obtain the graphene slurry. In an embodiment, the solvent is in an amount ranging from about 90 wt % to 99.999 wt %, including all values or ranges derivable therefrom.

In some embodiments, additive selected from a group comprising surfactant, wetting agent, dispersing agent, lubricating agent, defoaming agent, pH control agent, fabric coating agent and combinations thereof are optionally added to the graphene slurry.

In some embodiments, the solvent is selected from a group comprising water, alcohol, hydrocarbon and combinations thereof.

In some embodiments, the surfactant is selected a group comprising polyvinylpyrrolidone (PVP), sodium dodecyl sulfate (SDS), sodium lauryl sulfate (SLS), Sodium lauryl ether sulfate (SLES), Silicon and combinations thereof.

In some embodiments, the surfactant is in an amount ranging from about 0.05 wt % to 2 wt %, including all values or ranges derivable therefrom.

In some embodiments, the mixing of the graphene and the solvent is carried out by high shear mixing.

In some embodiments, mixing of the graphene and the solvent is carried out by high shear mixing to obtain homogenous and concentrated slurry.

In exemplary embodiments, the mixing of the graphene and the solvent is carried out at a mixing rate ranging from about 100 RPM to 10,000 RPM.

In exemplary embodiments, the mixing of the graphene slurry and the component selected from a group comprising surfactant, wetting agent, dispersing agent, lubricating agent, defoaming agent, pH control agent, fabric coating agent and combinations thereof is carried out at a mixing rate ranging from about 100 RPM to 10,000 RPM.

In some embodiments of the present disclosure, the preparation of the graphene slurry comprises dispersing graphene and/or its derivatives in a solvent and optionally along with a surfactant, in a high shear mixer, to prepare homogenous and concentrated graphene slurry

In some embodiments the concentrated graphene slurry is optionally mixed with agents including but not limited to wetting agent, dispersing agent, lubricating agent, defoaming agent, pH control agent and other standard/conventional coating agents, or combinations thereof.

In some embodiments of the present disclosure, the slurry is mixed with binder including but not limited to acrylate, polyurethane and combinations thereof before printing on the substrate. The ratio of the binder to the slurry is ranging from about 10:1 to 1:10. In an alternate embodiment, the ratio of the binder to the slurry is ranging from about 5:1 to 1:5.

In some embodiments, printing the substrate including but not limited to fabrics, polymers, plastics, material other than polymers such as conductors, metals, semiconductors and insulators with graphene slurry is carried out by technique including but not limited to screen printing transfer printing, INK jet Printing, Pigment Printing and gravure printing

In some embodiments, the graphene slurry is prepared to comprise graphene at a concentration higher than that at which it is present in the final fabric. Once the slurry is prepared and applied to the substrate and said substrate is processed as explained in the present disclosure, the final substrate that is yielded comprises graphene at a concentration of about 0.0001 wt % to 10 wt %, as defined herein.

In some embodiments, the wetting agent is selected from the group comprising cationic agent, anionic agent, non-ionic agent, amphoteric agent and combinations thereof.

In some embodiments, when present in the slurry, the wetting agent is in an amount of about 0.1% to 1% (w/w), including all values or ranges derivable therefrom.

In a non-limiting embodiment, when present in the slurry the wetting agent is at a concentration of about 0.1 wt %, about 0.2 wt %, about 0.3 wt %, about 0.4 wt %, about 0.5 wt %, about 0.6 wt %, about 0.7 wt %, about 0.8 wt %, about 0.9 wt % or about 1 wt %.

In some embodiments, the dispersing agent is selected from the group comprising cationic agent, anionic agent, non-ionic agent, amphoteric agent and combinations thereof.

In some embodiments, when present in the slurry, the dispersing agent, is in an amount of about 0.05% to 14% (w/w), including all values or ranges derivable therefrom.

In a non-limiting embodiment, when present in the slurry, the dispersing agent is at a concentration of about 0.05 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt % or 14 wt %.

In some embodiments, the lubricating agent is selected from the group comprising polyglycol ethers, silicone-based lubricant, mineral oil-based lubricant, other non-ionic lubricants and combinations thereof.

In some embodiments, when present in the slurry, the lubricating agent is in an amount of about 0.01% to 1% (w/w), including all values or ranges derivable therefrom.

In a non-limiting embodiment, when present in the slurry, the lubricating agent is at a concentration of about 0.01 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt % or about 1 wt %.

In some embodiments, defoaming agent is selected from the group comprising polyether, silicone polyether, and a combination thereof.

In some embodiments, when present in the slurry, the defoaming agent is in an amount of about 0.1% to 2% (w/w), including all values or ranges derivable therefrom.

In a non-limiting embodiment, when present in the slurry, the defoaming agent is at a concentration of about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, 1.1 wt %, about 1.2 wt %, about 1.3 wt %, about 1.4 wt %, about 1.5 wt %, about 1.6 wt %, about 1.7 wt %, about 1.8 wt %, about 1.9 wt % or about 2 wt %.

In some embodiments, the pH control agent is selected from the group comprising Auxigreen acid, citric acid, acetic acid and combinations thereof.

In some embodiments, when incorporated into the slurry, the pH control agent in an amount of about 0.1% to 1% (w/w), including all values or ranges derivable therefrom.

In a non-limiting embodiment, when incorporated into the slurry, the pH control agent is at a concentration of about 0.1 wt %, about 0.2 wt %, about 0.3 wt %, about 0.4 wt %, about 0.5 wt %, about 0.6 wt %, about 0.7 wt %, about 0.8 wt %, about 0.9 wt % or about 1 wt %.

In some embodiments, the method of preparing the graphene incorporated substrate of the present disclosure comprises:
a. preparing the graphene slurry;
b. optionally mixing the graphene slurry with the agent selected from the group comprising wetting agent, dispersing agent, lubricating agent, defoaming agent, pH control agent, fabric coating agent and combinations thereof; and
c. printing a substrate including but not limited fabrics, polymers, plastics, material other than polymers such as conductors, metals, semiconductors and insulators with the graphene slurry, to prepare the substrate comprising graphene at an amount ranging from about 0.0001% (w/w) to 10% (w/w), said fabric characterized feature selected from a group comprising anti-microbial, antistatic, anti-odour, wicking, thermal cooling, ultraviolet protection and combinations thereof.

In some embodiments, the method of preparing the graphene incorporated substrate of the present disclosure comprises:
a. preparing the graphene slurry;
b. optionally preparing a solution comprising wetting agent, dispersing agent, lubricating agent, defoaming agent, pH control agent, fabric coating agent, or any combination thereof; and
c. printing a substrate including but not limited fabrics, polymers, plastics, material other than polymers such as conductors, metals, semiconductors and insulators with the graphene slurry, optionally along with the solution of step b) to prepare the substrate comprising graphene at an amount ranging from about 0.0001% (w/w) to 10% (w/w), said substrate characterized by feature selected from a group comprising anti-microbial, antistatic, anti-odour, wicking, thermal cooling, ultraviolet protection and combinations thereof.

In some exemplary embodiments of the present disclosure, the method for production of graphene incorporated substrate comprises:
a. preparing graphene slurry by dispersing graphene and/or its derivatives in water, optionally along with a surfactant, in a high shear mixer to obtain homogenous and concentrated slurry;
b. optionally mixing the graphene slurry with coating agents; and
c. printing a substrate with the slurry, to prepare the graphene incorporated substrate.

In some exemplary embodiments of the present disclosure, the method for production of graphene incorporated substrate comprises:
a. preparing graphene slurry by dispersing graphene and/or its derivatives in water, optionally along with a surfactant, in a high shear mixer to obtain homogenous concentrated slurry;
b. optionally mixing the graphene slurry with coating agents; and
c. screen printing of a substrate with the slurry, to prepare the graphene incorporated substrate.

In an exemplary embodiment of the present disclosure, method for production of graphene incorporated substrate further comprises:
performing reduction clearing, and
carrying out acid neutralization, washing and drying, to prepare the graphene incorporated substrate.

Accordingly, in some embodiments, the method of production of graphene incorporated substrate comprises:
a. printing a substrate including but not limited fabrics, polymers, plastics, material other than polymers such as conductors, metals, semiconductors and insulators with the graphene slurry;
b. performing reduction clearing, and
c. carrying out acid neutralization, washing and drying, to prepare the graphene incorporated substrate.

In a non-limiting embodiment, the aforesaid method and described variants thereof print the graphene on the surface of the substrate or infuses the graphene onto the substrate or achieves a combination of both.

The substrate including but not limited fabrics, polymers, plastics, material other than polymers such as conductors, metals, semiconductors and insulators comprising graphene obtained by the aforesaid method retains the anti-microbial, antistatic, anti-odour, wicking, thermal cooling and ultraviolet protection features after 50 washes or more.

In some embodiments of the present disclosure, the preparation/production of graphene incorporated substrate including but not limited fabrics, polymers, plastics, material other than polymers such as conductors, metals, semiconductors and insulators is achieved by a one-step industrially adapted large-scale mass production printing technique including but not limited to screen printing without the involvement of post processing techniques.

In some embodiments of the present disclosure, the graphene is infused/incorporated during synthesis/production of fabrics. In other embodiments of the present disclosure, the graphene is infused/incorporated in the synthesized/produced fabrics or virgin fabrics.

The present disclosure further relates to use of graphene slurry comprising graphene at an amount ranging from about 0.0001% w/w to 20% w/w for preparing a substrate comprising graphene at an amount ranging from about 0.0001 to 10% (w/w) and characterized by features selected from a group comprising anti-microbial, antistatic, anti-odour, wicking, thermal cooling ultraviolet protection and combinations thereof.

In some embodiments, the use comprises preparing the graphene slurry is homogenous and concentrated comprises graphene at a concentration higher than that at which it is present in the final substrate including but not limited fabrics, polymers, plastics, material other than polymers such as conductors, metals, semiconductors and insulators and applying the same to the substrate. Once the slurry is prepared and applied to the substrate and said substrate is processed as explained in the present disclosure, the final substrate that is yielded comprises graphene at a concentration of about 0.0001 wt % to 10 wt %, as defined herein. In some embodiments, the aforesaid use comprises preparing a graphene slurry comprising graphene in an amount ranging from about 0.0001 wt % to 20 wt %, followed by its application to the substrate to yield a substrate comprising graphene at an amount ranging from about 0.0001 to 10% (w/w).

As mentioned above, the graphene in the aforesaid use is a graphene, a graphene derivative or a combination thereof.

In preferred embodiments, in the aforesaid use, the graphene slurry comprises graphene, solvent and optionally a surfactant. In further embodiments, the graphene slurry additionally comprises agents selected from the group comprising wetting agent, dispersing agent, lubricating agent, defoaming agent, pH control agent, fabric coating agent, and combinations thereof. Each of said agents referred to herein is defined in earlier embodiments.

To enable preparation of the graphene incorporated substrate of the present disclosure, the present disclosure further provides a homogenous and concentrated graphene slurry comprising graphene at an amount ranging from about 0.0001 to 20 wt %. In some embodiments, the graphene slurry additionally comprises components selected from a group comprising surfactant, wetting agent, dispersing agent, lubricating agent, defoaming agent, pH control agent, fabric coating agent and combinations thereof, wherein the wetting agent, the dispersing agent, the lubricating agent, the defoaming agent and the pH control agent are defined in earlier embodiments are not repeated herein for reasons of brevity.

In some embodiments, the graphene in said slurry is a graphene, a graphene derivative or a combination thereof.

In some embodiments, the graphene slurry is prepared to comprise graphene at a concentration higher than that at which it is present in the final substrate. Once the slurry is prepared and applied to the substrate and said substrate is processed as explained in the present disclosure, the final substrate that is yielded comprises graphene at a concentration ranging from about 0.0001 wt % to 10 wt %, as defined herein.

The present disclosure further provides a method of preparing the graphene slurry as defined above, the method comprising:
i) dispersing graphene in a solvent and optionally a surfactant followed by mixing, to prepare a graphene slurry; and
ii) optionally mixing the graphene slurry with agents selected from the group comprising wetting agent, dispersing agent, lubricating agent, defoaming agent, pH control agent, fabric coating agent, and combinations thereof.

The graphene, solvent, surfactant, wetting agent, dispersing agent, lubricating agent, defoaming agent, pH control agent and the fabric coating agent employable in the above method are provided in earlier embodiments and are not repeated for reasons of brevity.

The present disclosure further provides use of the graphene incorporated substrate having graphene at an amount ranging from about 0.0001% w/w to 10% w/w in applications/manufacture of commercial products including but not limited to textile products in medical applications/hospitals such as aprons, garments, furniture covers, bed covers, pillow covers, curtains, other apparels, upholstery, carpets and bags.

To solve the need in the art for enhanced substrate, the present disclosure provides graphene incorporated substrate comprising graphene at relatively low concentration in an amount ranging from about 0.0001% w/w to 10% w/w. Advantages of the substrate comprising graphene of the present disclosure include but are not limited to—
beneficial properties at low concentrations of graphene and/or its derivatives;
very good/excellent washing fastness, rubbing fastness, perspiration fastness, sublimation fastness and light fastness;
retention of the beneficial properties discussed above along with excellent washing, rubbing, perspiration, sublimation and light fastness features even after multiple washes of the fabric thus providing excellent stability to the fabric after repeated washing cycles;
enhanced anti-microbial, antistatic, anti-odour, wicking, thermal cooling and ultraviolet protection as compared to unprocessed fabrics;
economical, repeatable and commercially/industrially viable process for production.

Throughout the present disclosure, the term ‘graphene derivatives’, ‘derivatives of graphene’ or the likes is intended to convey the ordinary conventional meaning of the term known to a person skilled in the art and intends to cover structural analogs of graphene, or compounds derived from graphene and having similar characteristics of graphene. In some embodiments of the disclosure, graphene derivatives encompass graphene nanoplatelets, graphene oxides, reduced graphene oxides, functionalized graphene, graphene decorated with metal particles, nanosized graphene, graphene quantum dots or any graphene containing material. However, in the context of the present disclosure, any derivative of graphene must in-turn be a combination of single and multi-layered graphene derivative and comprise about 75% to about 85% of single layered graphene derivative, and about 15% to about 25% multi-layered graphene derivative, wherein the multi-layered graphene derivative is made up of about 2 to about 5 layers of graphene.

Further, all references to graphene within the present disclosure also intends to cover its derivatives, unless explicitly stated otherwise. Thus, any embodiment referring to graphene is meant to be extrapolated to any derivative of graphene as well, unless explicitly stated otherwise.

While the present disclosure is susceptible to various modifications and alternative forms, specific aspects thereof have been shown by way of examples and drawings and are described in detail below. However, it should be understood that it is not intended to limit the invention to the particular forms disclosed, but on the contrary, the intention is to cover all modifications, equivalents, and alternatives falling within the spirit and the scope of the invention as defined by the appended claims.

### EXAMPLES

The present disclosure is further described with reference to the following examples, which are only illustrative in nature and should not be construed to limit the scope of the present disclosure in any manner.

### Example 1: Preparing Substrate Comprising Graphene

A water-based graphene slurry is prepared using high shear mixer. Graphene is dispersed in water using high shear mixer to obtain a homogeneous and concentrated slurry. Said homogeneous and concentrated slurry is optionally mixed with components selected from a group comprising surfactant, wetting agent, dispersing agent, lubricating agent, defoaming agent, pH control agent, fabric coating agent. The obtained graphene slurry is employed for printing on the substrate including but not limited fabrics, polymers, plastics, material other than polymers such as conductors, metals, semiconductors and insulators, the printing technique includes but it is not limited to screen printing to obtain substrate comprising graphene/graphene incorporated substrate, wherein the graphene is at an amount ranging from about 0.0001% w/w to 10% w/w.

### Example 2: Preparing Graphene Slurry

A water-based graphene slurry was prepared by using high shear mixer. About 1 kg of multilayer Graphene (of 2 to 3 layers) having surface area of about 400 to 500 m²/g was dispersed in about 48.8 kg of water for about 3 hours using high shear mixer to obtain a homogeneous and concentrated slurry. About 0.2 kg PVP (Polyvinyl pyrrolidone) was added in the said amount of water and mixed for about 15 minutes at about 6000 rpm prior to the graphene addition step.

### Example 3: Preparing Substrate Comprising Graphene

About 250 gm of the prepared graphene slurry prepared in Example 2 was mixed with about 172 gm of binder, about 4.8 gm of thickener, about 8 gm of fixer, about 4 gm of emulsifier and about 8 gm softener in an overhead stirrer until the mixture was homogenized. Next the required quantity of the mixture was applied on the printing screen frame by keeping it on the substrate (for e.g., PET fabric). The mixture on the screen was wiped vertically from top to bottom of the screen with the wiper to get an impression on the fabric to be printed. During wiping the mixture was transferred to fabrics through the screen holes. The process was repeated for about 2 to 4 times to get better continuity of the printing on the fabric surface. The print on the fabric was dried in a continuous hot air drying woven with a fabric speed of about 6 to 8 m/min at a temperature of about 150° C.

### Example 4: Preparing Substrate Comprising Graphene

About 175 gm of prepared graphene slurry prepared in example 2 was mixed with about 120.7 gm of binder, about 3.3 gm of thickener, about 5.6 gm of fixer, about 2.8 gm of emulsifier and about 5.6 gm softener in an overhead stirrer until homogenized. Next the required quantity of the mixture was applied on the printing screen frame by keeping it on the PET fabric. The mixture on the screen was wiped vertically from top to bottom of the screen with the wiper to get an impression on the fabric to be printed. During wiping the mixture was transferred to fabrics through the screen holes. The process was repeated for about 2 to 4 times to get better continuity of the printing on the fabric surface. The print on the fabric was dried in a continuous hot air drying woven with a fabric speed of about 6 to 8 m/min at a temperature of 150° C.

### Example 5: Characteristic Features of the Substrate Comprising Graphene

The graphene incorporated substrate (fabric) obtained in Example 3 comprises graphene and/or its derivatives at a concentration of about 0.5 wt % with respect to the weight of the fabric. The fabric shows electrical resistance of about 800 ohm and resistivity of about 600 ohm-m. The fabric exhibits bactericidal effect of about 99.95% against Staphylococcus aureus, Klebsiella pneumonia, and Escherichia coli when analyzed as per AATCC 100-2012 test Method. The substrate comprising graphene also demonstrates antistatic effect measured by half decay time for discharge of charge applied on the substrate surface which ranges from 1.25 s. The substrate comprising graphene is characterized by thermal cooling measured by Q-Max which ranges from about 0.21 W/cm² (dry) and 0.319 W/cm² (wet).

### Example 6: Characteristic Features of the Substrate Comprising Graphene

The graphene incorporated substrate (fabric) obtained in Example 4 comprises graphene and/or its derivatives at a concentration of about 2 wt % with respect to the weight of the fabric. The fabric shows electrical resistance of about 80 ohm and resistivity of 75 ohm-m. The fabric also shows 39 cm vertical moisture wicking (length) and 49 cm vertical moisture wicking (width) in about 30 minutes according to AATCC197:2013. The graphene incorporated fabric also shows drying which is about 59.05% of the fabric containing no graphene according to PHX-APO-607. The anti-viral studies performed on the graphene incorporated fabric (substrate) shows about 99.92% antiviral effect against MS2 bacteriophage as per AATCC 100-2012 test Method. The graphene incorporated fabric (substrate) shows about 126.88 UPF (ultraviolet protection factor) as per AATCC 183-2014/ASTM D 6603-11 testing standards.

Additional embodiments and features of the present disclosure will be apparent to one of ordinary skill in art based on the description provided herein. The embodiments herein provide various features and advantageous details thereof in the description. Descriptions of well-known/conventional methods and techniques are omitted so as to not unnecessarily obscure the embodiments herein.

The foregoing description of the specific embodiments fully reveals the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments in this disclosure have been described in terms of preferred embodiments, those skilled in the art will recognize that the embodiments herein can be practiced with modification within the spirit and scope of the embodiments as described herein.

Throughout this specification, the word “comprise”, or variations such as “comprises” or “comprising” wherever used, will be understood to imply the inclusion of a stated element, integer or step, or group of elements, integers or steps, but not the exclusion of any other element, integer or step, or group of elements, integers or steps. The term “about” is used herein to mean approximately, in the region of, roughly, or around. When the term “about” is used in conjunction with a numerical value/range, it modifies that value/range by extending the boundaries above and below the numerical value(s) set forth. In general, the term “about” is used herein to modify a numerical value(s) above and below the stated value(s) by a variance of 20%.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

As regards the embodiments characterized in this specification, it is intended that each embodiment be read independently as well as in combination with another embodiment. For example, in case of an embodiment 1 reciting 3 alternatives A, B and C, an embodiment 2 reciting 3 alternatives D, E and F and an embodiment 3 reciting 3 alternatives G, H and I, it is to be understood that the specification unambiguously discloses embodiments corresponding to combinations A, D, G; A, D, H; A, D, I; A, E, G; A, E, H; A, E, I; A, F, G; A, F, H; A, F, I; B, D, G; B, D, H; B, D, I; B, E, G; B, E, H; B, E, I; B, F, G; B, F, H; B, F, I; C, D, G; C, D, H; C, D, I; C, E, G; C, E, H; C, E, I; C, F, G; C, F, H; C, F, I, unless specifically mentioned otherwise.

Any discussion of documents, acts, materials, devices, articles and the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

While considerable emphasis has been placed herein on the particular features of this disclosure, it will be appreciated that various modifications can be made, and that many changes can be made in the preferred embodiments without departing from the principles of the disclosure. These and other modifications in the nature of the disclosure or the preferred embodiments will be apparent to those skilled in the art from the disclosure herein, whereby it is to be distinctly understood that the foregoing descriptive matter is to be interpreted merely as illustrative of the disclosure and not as a limitation.

All references, articles, publications, general disclosures etc. cited herein are incorporated by reference in their entireties for all purposes. However, mention of any reference, article, publication etc. cited herein is not, and should not be taken as, an acknowledgment or any form of suggestion that they constitute valid prior art or form part of the common general knowledge in any country in the world.

1. A substrate comprising graphene or its derivative,
wherein an amount of the graphene or its derivative in the substrate is from about 0.0001% (w/w) to 10% (w/w), wherein the substrate is characterized by a feature selected from the group consisting of electrical resistance, electrical resistivity, antimicrobial, antistatic, anti-odour, wicking, thermal cooling, ultraviolet protection, and combinations thereof.

2. The substrate as claimed in claim 1, wherein the graphene comprises about 80% to 85% of a single layer graphene and about 15% to 20% few layers graphene, and wherein the few layers graphene comprises about 2 to 5 layers of graphene.

3. The substrate as claimed in claim 1, wherein the graphene has a surface area ranging from about 300 m²/g to 800 m²/g.

4. The substrate as claimed in claim 1, wherein the substrate is selected from the group consisting of fabric, polymer, plastic, conductor, metal, semiconductor, insulator, and combinations thereof.

5. The substrate as claimed in claim 4, wherein the substrate is selected from the group consisting of natural fabric, synthetic fabric, blend of natural and synthetic fabric, and combinations thereof.

6. The substrate as claimed in claim 1, wherein the substrate has electrical resistance ranging from about 50 Ohm to 1000 k Ohm.

7. The substrate as claimed in claim 1, wherein the substrate has electrical resistivity ranging from about 50 Ohm/sq to 1600 k Ohm/sq.

8. The substrate as claimed in claim 1, wherein the substrate has bactericidal effect ranging from about 90% to 99.999%; the substrate has bacteriostatic effect ranging from about 90% to 99.999%; the substrate has antiviral effect ranging from about 90% to 99.99%; and the substrate has antifungal effect ranging from about 90% to 99.999%.

9. The substrate as claimed in claim 1, wherein the substrate has anti-odour effect ranging from about 90% to 99.999%; the substrate has thermal cooling ranging from about 0.1 W/cm² to 0.7 W/cm²; and the substrate has ultraviolet protection factor (UPF) ranging from about 30 to 130; and the substrate has antistatic effect for discharge of charge applied on the substrate ranging from about 0.1 seconds to 3 seconds.

10. The substrate as claimed in claim 1, wherein the feature selected from the group consisting of electrical resistance, electrical resistivity, antimicrobial, antistatic, anti-odour, wicking, thermal cooling, ultraviolet protection, and combinations thereof are maintained up to at least 50 washes.

11. A method of preparing the substrate as claimed in claim 1, said method comprises:
preparing a graphene slurry; and
printing a substrate with the graphene slurry to obtain the substrate.

12. The method as claimed in claim 11, wherein the graphene slurry is prepared by dispersing graphene in a solvent, followed by mixing to obtain the graphene slurry, wherein the solvent is selected from the group consisting of water, alcohol, hydrocarbon, and combinations thereof, and wherein the solvent is in an amount ranging from about 90 wt % to 99.999 wt %.

13. The method as claimed in claim 12, wherein the graphene slurry comprises additive selected from the group consisting of surfactant, wetting agent, dispersing agent, lubricating agent, defoaming agent, pH control agent, fabric coating agent, and combinations thereof.

14. The method as claimed in claim 13, wherein the surfactant is in an amount ranging from about 0.05 wt % to 2 wt %, the wetting agent is in an amount ranging from about 0.1% to 1% w/w, the dispersing agent is an amount ranging from about 0.05% to 14% w/w, the lubricating agent is in an amount ranging from about 0.01% to 1% w/w, the defoaming agent is in an amount ranging from about 0.1% to 2% w/w, and the pH control agent is in an amount ranging from about 0.1% to 1% w/w.

15. The method as claimed in claim 11, wherein the graphene slurry is mixed with a binder prior to printing on the substrate, wherein the binder is selected from the group consisting of acrylate, polyurethane, and combination thereof, and wherein a ratio of the binder to the slurry is ranging from about 10:1 to 1:10.

16. The method as claimed in claim 11, wherein the graphene slurry comprises graphene at a concentration ranging from about 0.0001% w/w to 20% w/w.

17. The method as claimed in claim 11, wherein the printing is carried out by a technique selected from the group consisting of screen printing, transfer printing, INK jet printing, pigment printing, gravure printing, and combination thereof.

18. The method as claimed in claim 11, further comprising:
performing reduction clearing; and carrying out acid neutralization, washing and drying.

19. The substrate as claimed in claim 1, wherein the graphene has a surface area ranging from about 400 m²/g to 500 m²/g.
